(19) United States
(12) Patent Application Publication
(10) Pub. No.: US 2008/0155830 A1
(43) Pub. Date: Jul. 3, 2008

(54) Package opener

(76) Inventors: Richard Leifer, Melville, NY (US); Alan Randmae, Northport, NY (US); Rein Randmae, Northport, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/646,647

(22) Filed: Dec. 28, 2006

(51) Int. Cl. B67B 7/00

(52) U.S. Cl. 30/2

(57) ABSTRACT

A package opener having a rotating cutting wheel and adapted to cut and open packages having dye cut edges/flanges, or more specifically clamshell packages. An opposing groove is positioned to receive the blade of the cutting wheel. The package opener includes an edge receiving portion that is configured to receive the flange of the package and allow the opener to be moved along the same. The moving action results in an engagement of the package between the cutting wheel and the opposing groove, and the cutting of the same without any exertion or discomfort to the user.

### BACKGROUND

1. Field of Technology

The present principles relate to packaging openers, and more particularly, they relate to a package opening device for opening clamshell packaging.

2. Description of Related Art

The use of clamshell packaging is very widespread throughout the retail industry. The implementation of such packaging has enabled manufacturers to provide safe packaging for their products, while at the same time enabling the clear display of the product and/or product inserts without costly additions to the packaging process.

In addition, the technology of the clamshell manufacturing process has also enabled a built-in hanger and/or ‘feet’ to allow the package to be hung on a display rack and/or stand on a display counter without requiring additional hangers or supports. Thus, for at least the above reasons, clamshell packages have become commonplace in the retail world.

Clamshell packaging, however, suffers from one major drawback. The drawback is mainly the difficulty to open these packages that have been heat-sealed closed during the manufacturing process. The heat sealing is generally performed along the outer periphery of the clam shell, or the die cut edge flange. The plastic used in these packages is strong, and difficult, if not impossible to rip open manually. As such, the purchaser is often required to cut the package open with a sharp razor blade or knife, which subjects the purchaser to a high possibility of a self-inflicted injury due to the often unusual and varied shapes of the clamshell packages. Indeed, during the opening of these clamshell packages, the purchaser is often either injured, or the contents of the package are damaged.

Thus, it would be desirable to provide a tool or device for opening a clamshell package accurately that eliminates the need for the purchaser to use knives or other potentially dangerous instruments to open the package and which enables the purchaser to easily open the package without damaging the contents thereof.

### SUMMARY

It is therefore an aspect of the invention to provide a clamshell package opener that provides a safe and easy way for opening such packages.

It is yet another aspect of the invention to provide a clamshell package opener that does not subject the user to exposure to sharp instruments.

A further aspect of the invention is to provide a clamshell package opener that does not damage the contents of such package.

These and other aspects are achieved in accordance with an embodiment of the present principles wherein a clamshell package opener includes

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numerals denote similar components throughout the views:

FIG. 1 is a perspective view of an exemplary clamshell package;

FIG. 2 is an enlarged view of the die cut edge of an exemplary clamshell package;

FIG. 3 is left side perspective view of the package opener (with the housing removed) according to an embodiment of the present principles;

FIG. 4 is an enlarge view of the cutting wheel action of the package opener (with housing removed), according to another embodiment of the present principles;

FIG. 5 is a perspective view of a motorized version of the package opener (with housing removed), according to a further embodiment of the present principles;

FIG. 6 is an enlarged right side perspective view of the package opener (with the housing removed) according to an embodiment of the present principles;

FIG. 7 is a perspective view of the package opener, partially shown in phantom, according to another embodiment of the present principles;

FIG. 8 is a perspective view of the package opener, partially shown in phantom, according to another embodiment of the present principles;

FIG. 9 is a perspective view of the package opener, according to yet another embodiment of the present principles; and

FIG. 10 is a perspective view of the package opener according the an even further embodiment of the present principles.

### DETAILED DESCRIPTION

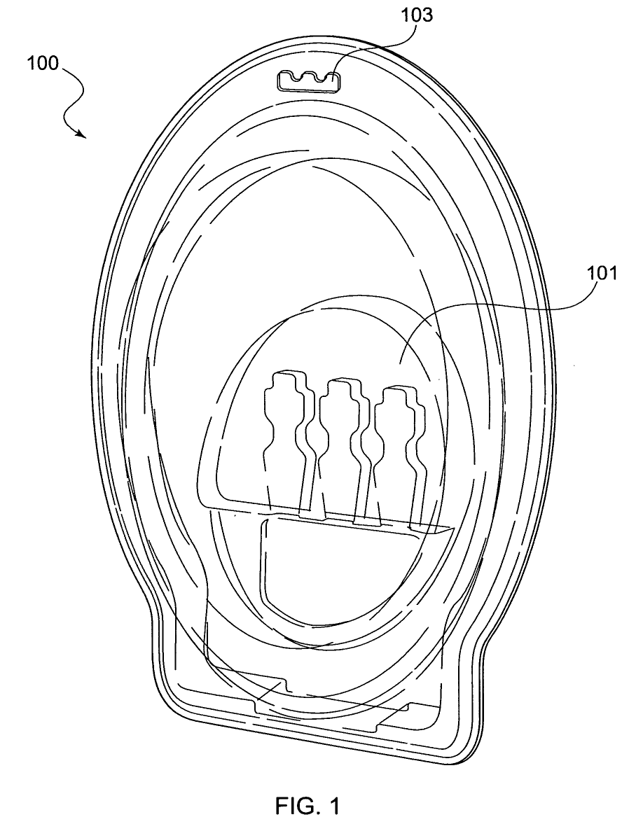

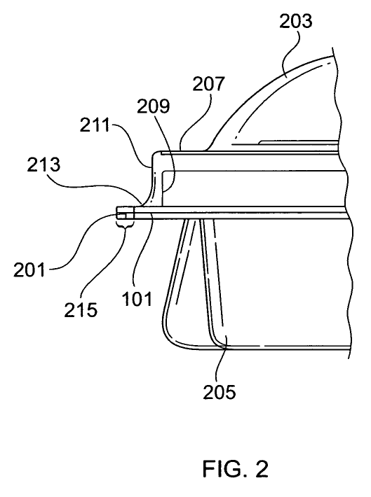

Referring to FIGS. 1 and 2, an exemplary clamshell package 100 is shown having a die cut edge 101 defining a flange 201 around the entire peripheral edge of the package. A top clam portion 203 is joined with a base portion 205 along a structural flange 207, and adhered to the same via the die cut edge 101. The clamshell package can include a die cut hanging hole 103 for allowing the sealed clamshell package to be hung on a display rack. In other forms (not shown), the clamshell can include molded feet like structures in the bottom which enable the sealed clamshell package to stand on a display counter, or in a display box.

The die cut edge 101 of the flange 201 includes a portion 215 along the outer most periphery where the actual heat is applied and the upper clam 203 and lower clam 205 are physically connected. The upper clam 203 has a lower portion 211 that meets with the upper portion 209 of the lower package 205 to form the flange 201 and ultimately the die cut edge 101. As shown, the die cut edge 101 includes the sealed portion 215 and an adjacent unsealed portion 213 where the upper clam 203 and lower clam 205 are together, but not sealed. It is in this area of adjacent portion 213 where it is preferred to cut open the package such that any inserts supported by structural flange 207 and/or any products contained in the package are not damaged during opening.

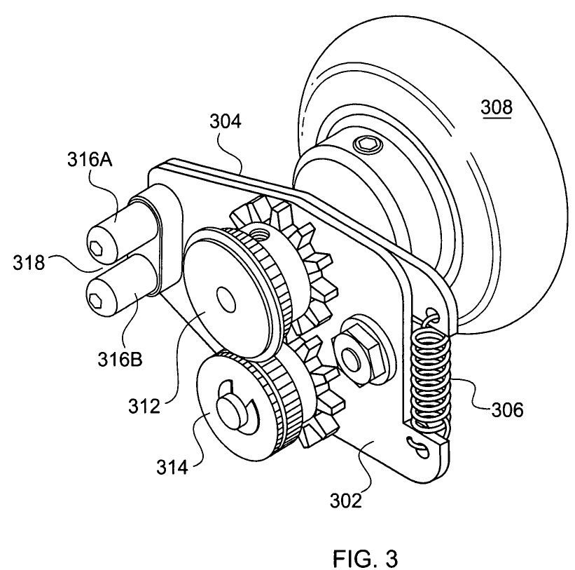

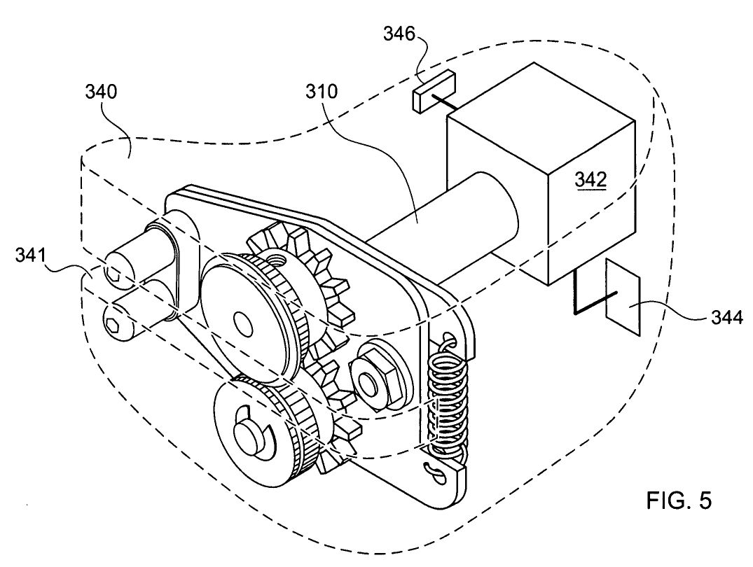

Referring generally to FIGS. 3-6, there is shown a package opener 300 according to an aspect of the present principles. The package opener 300 is shown in FIGS. 3, 4 and 6 as a manual device, and in FIG. 5 as a motorized version of the same.

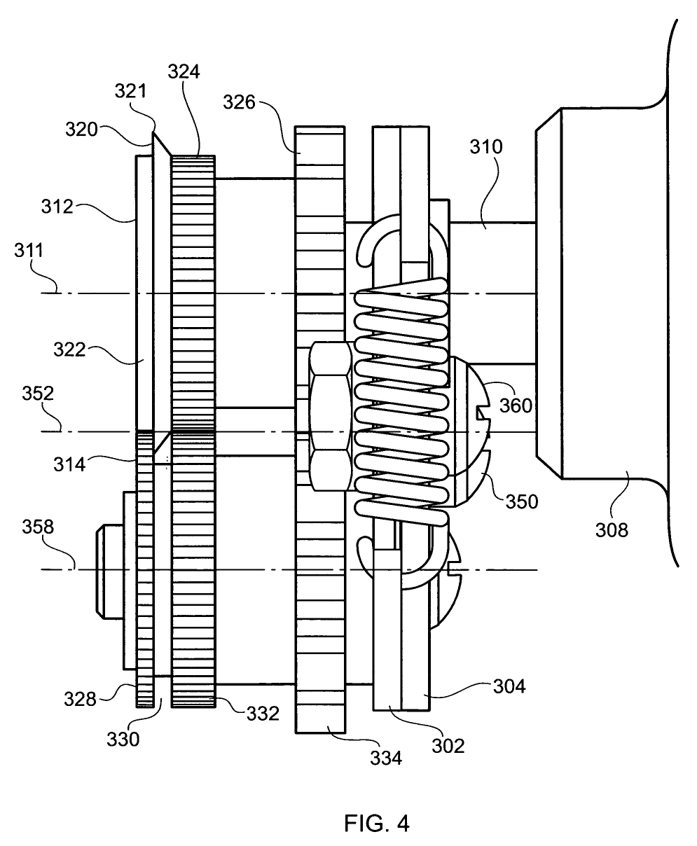

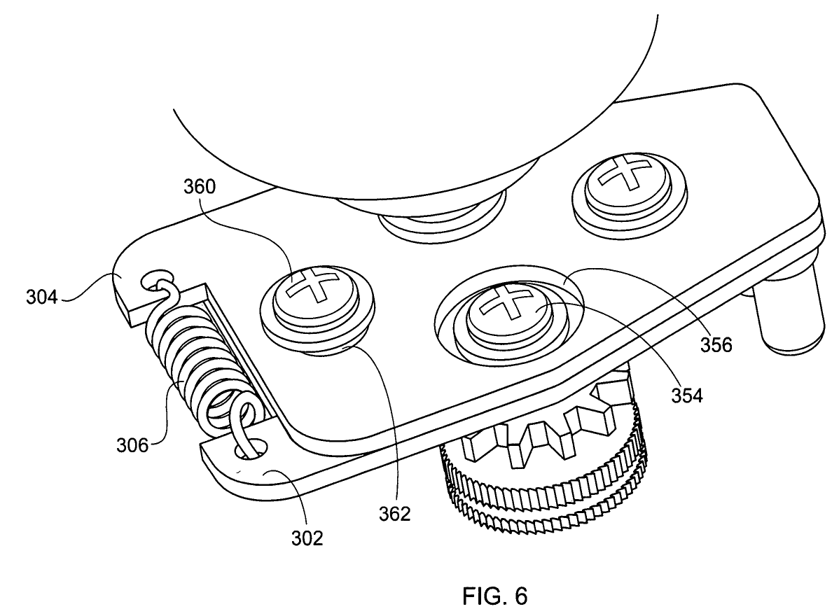

The package opener 300 is made up of two plates 302 and 304 what are sandwiched together and are pivotal about an axis 352 (FIG. 4). The two plates 302 and 304 or retained in a predetermined pivotal position by an extension spring 306. This pivotal action of the opener 300 will be described in further detail later with reference to FIG. 6. The use of spring 306 is optional but may be required if the plates pivot. If the plates are fixed, then no spring is required. Those of skill in the art will recognize that spring 306 maintains the two plates 302 and 304 (and corresponding wheels 312 and 314) in a predetermined position with respect to each other. Although shown with two plates 302 and 304, it is contemplated herein to combine these plates into one single plate such that the construction is manufactured more simply.

An upper blade wheel 312 is rotationally mounted on plate 304. In one embodiment, the cutting wheel 312 is connected to a shaft 310 of the manual rotating knob 308. The blade wheel 312 includes an outer circumferential surface 322, a blade 320 and an inner circumferential surface 324. A lower slotted friction wheel 314 is rotationally mounted on plate 302 and includes an outer circumferential surface 328, a slot or channel 330 and an inner circumferential surface 332. The blade wheel 312 includes a gearing 326 that is adapted to mesh with a gearing 334 on the slotted friction wheel 314.

The surfaces 328 and 332 preferably have an increased coefficient of friction and cooperate with the opposing surfaces 322 and 324, respectively, so as to provide a strong frictional grip of the package between the respective surfaces of wheels 312 and 314, and thereby force the same through the cutter when rotated. Although shown in a ratcheted form, those of skill in the art will recognize that other forms and types of increased friction surfaces can be used in place of the ratcheted form shown. For example, the surfaces 322, 324, 328 and 332 can be a featureless smooth surface, or a frictional over mold (e.g., urethane) for the purpose of driving the wheels via the surface of the package to facilitate rotation.

The slot or groove 330 in the cutting wheel 314 enables the cutting of the package using a shearing force. Rather than puncture the package using a downward force of the cutting blade into the groove, the package opener 300 uses a shearing action to begin the cutting operation. This shearing action is maintained while the cut is in progress as well. This cutting action may be referred to as rotary shear die cutting, whereby the grooved or slotted wheel 314 acts like a die at any moment in time while cutting.

The cutting wheel 312 is rotationally mounted on a shaft 310 that is connected to a manual knob 310 or a motor (FIG. 5). The cutting wheel 312 includes a gearing 326 that is adapted to cooperate with a similar or identical gearing 334 on the slotted wheel 314. As shown, the wheels 312 and 314 are geared together for the highest performance. Those of skill in the art will recognize that the gearing (326, 334) can be any suitable type gearing or an equivalent thereof. For example, the gearing can be remotely positioned from the wheels, and may be translated using a chain, a belt, or a variety of other gear types.

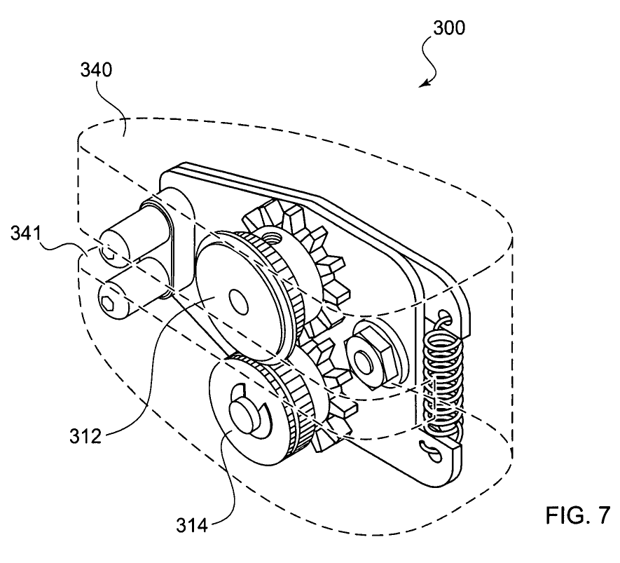

There are three potential modes of operation of the opener 300 according to the present principles: 1) a first manual mode where the opener, without the knob 308, is used. In this mode, the user manually pulls the opener over the edge of the clamshell package and engages the same between the cutting wheel 312 and the slotted friction wheel 314 (See FIGS. 7-10); 2) a second manual mode where the knob 308 is included and the user rotates the knob to move the cutter along the package; and 3) a motorized, or automatic mode, where a motor 342 is actuated by the user and it drives the cutting wheel 312 of the opener.

Upon rotation cutting wheel 312, gearing 326 causes the slotted wheel 314 to rotate at the same speed, and in an opposite direction. The package is sandwiched between the wheels and the blade 320 cooperates with the slot/groove 330 to provide a shearing action and cut the package open along the die cut edge 101.

The blade 320 on wheel 312 has a razor sharp angular cutting protrusion 321 circumferentially disposed there around, and the groove 330 includes a sharp edge 331 on the side that mates with the blade 320. The axial clearances of the blade 320 and groove 330 with edge 331 are built in, and do not change, so as to provide optimum cutting action. The groove 330 is preferably larger than the blade 320 so as to provide additional space or clearance for deformed plastic material of the package.

Referring specifically to FIG. 3, at the leading side of the opener 300, there are two round stand offs 316A and 316B fixedly attached to the plate 302 and having a predetermined spacing 318. When operating in a manual mode with rotating knob 308, stand offs 316A and 316B function to rotationally stabilize the cutter. When using the knob 308 or other manual rotation means (i.e., not the manual mode where the user pulls the device over the package), the rotational force or torque is translated to the plates 302 and 304 and thereby the cutter itself. As such, the tendency is for the cutter 300 to twist the wheels 312 and 314 with respect to the die cut edge of the package. Stand-offs 316 operate to eliminate any twisting of the cutter with respect to the die cut edge and thereby maintain the wheels 312 and 314 in their proper configuration during rotation of the shaft 310 via knob 308. These stand offs 316 are not necessary for the motorized embodiment shown in FIG. 5, as the motor does not impart rotational forces on the cutter itself, and therefore eliminates the need for additional rotational stabilization.

Referring to FIG. 5, there is shown a motorized version of cutter 300 according to an embodiment of the present principles. A housing 340 encases the mechanism shown in FIGS. 1-4 and 6, and further shows a motor 342 attached to the shaft 310. A battery 344 of any suitable known type is provided and a switch 346 selectively activates the motor 342. The housing 340 includes a keyway or slot 341 that receives the die cut edge of the package and has a predetermined depth and all requisite clearances so as to provide optimum cutting adjacent the package flange 201 in the area identified as 213 in FIG. 2. As mentioned above, the rotational stabilizing stand offs 316 are not required for the motorized version of the opener 300, as the motor does not impart rotational forces (i.e., torque) on the cutter itself.

FIG. 6 shows the opposite side of the opener 300 showing the plate connection and wheel mounting more clearly. As shown, the two plates 302 and 304 are pivotally connected by fastener 350. The slotted friction wheel 314 is rotatably mounted to the plate 302. The plate 304 includes a hole 356 that accommodates fastener 354. The hole 356 is large enough so as to allow for movement of the plate 302 with respect to plate 304. A second fastener 360 is fastened to plate 302 through a slot 362 in plate 304. The slot 362 provides the necessary clearance for the two plates to pivot about axis 353 of the fastener 350. As mentioned above, a spring 306 can be used to maintain plates 302 and 304, and thereby cutting wheel 312 and slotted friction wheel 314 in constant contact with the package at all times during operation.

Referring to FIG. 7, there is shown a preferred embodiment of the present principles. In this embodiment, the opener 300 is contained in a housing 340 having a longitudinal slot 341. The housing 340 is shown in phantom to facilitate the view of the inner workings of the opener 300. The housing 340 operates as a shield from the cutting blade and the inner workings of the cutter. Although shown in the form of a complete housing in this embodiment, it is to be understood that any type of shield, either partial or complete can be implemented for limiting or preventing exposure of the cutting blade and any other internal workings of the cutting device.

In this embodiment, the housing 340 is positioned such that the dye cut edge of the package 201 is full inserted into the slot 341. Once inserted, the user pulls the opener 300 along the die cut edge. The dye cut edge will be sandwiched between the cutting wheel 312 and the recess 330 and as the opener is pulled along the edge, the cutting wheel 312 will cut the package in an area immediate adjacent the dye cut bonded portion 215 of the package flange 101. Those of skill in the art will recognize that the depth of the slot 341 can be specifically designed and adapted to provide the required clearance such that the opener cuts inside the dye cut bonded portion 215 so as to open the package.

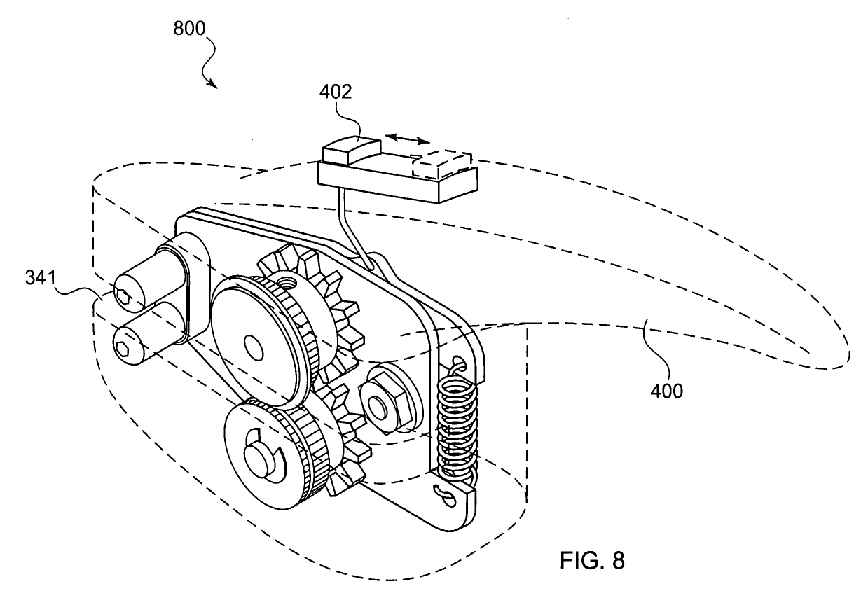

FIG. 8 shows another embodiment of the opener 800, where a handle 400 is provided with a trigger 402. The trigger 402 is mechanically connected to the internal cutting device such that when retracted in a rearward direction, the cutting wheel 312 is moved upward away from the receiving wheel 314 such that the package edge can more easily be inserted into the slot 341. Once inserted into the slot 341, the trigger 402 can be moved forward (or in a direction that enables the downward movement of the cutting wheel 312, into engagement with the package), such that the cutting wheel engages the surface of the package. Once the trigger 402 is engaged into cutting mode, the user pulls on the handle 400 and thereby pulls the opener 800 along the edge of the package to cut the same open.

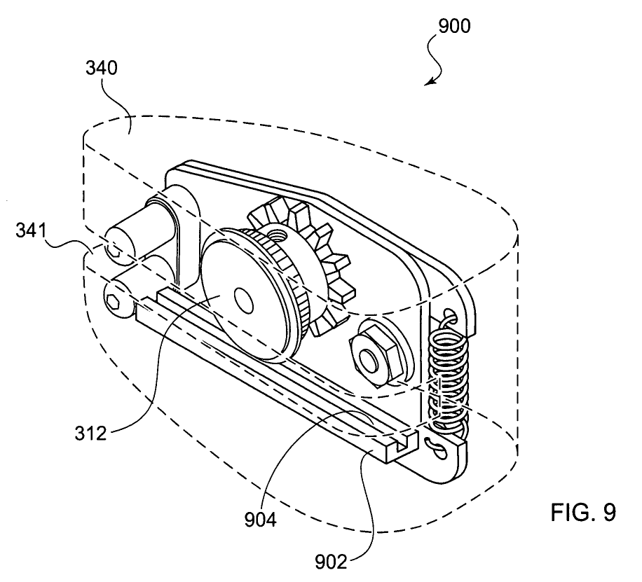

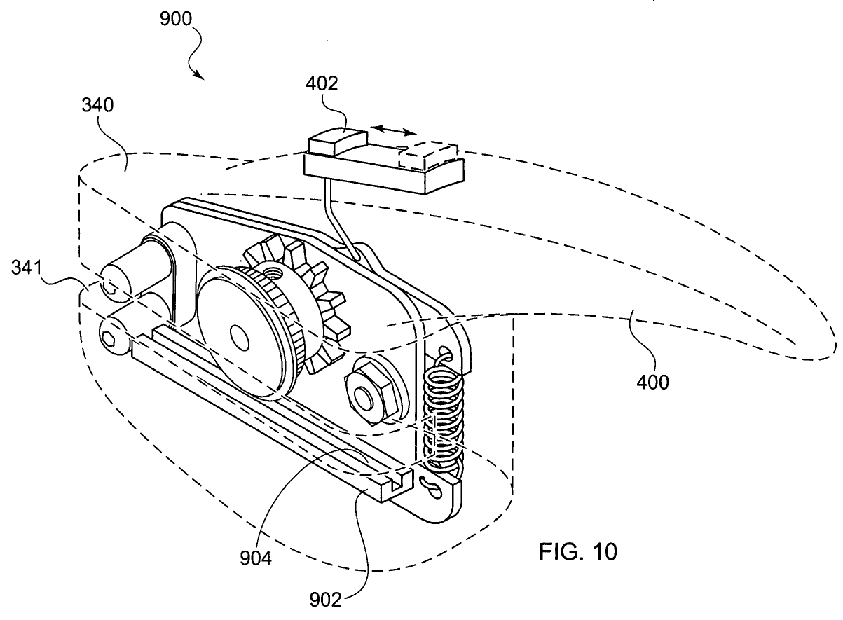

FIGS. 9 and 10 show another embodiment of the package opener 900 according to the present principles. In this embodiment, the lower slotted wheel 314 has been removed, and replaced with a rail 902 having a longitudinal groove or slot 904. The blade 320 of the outer circumferential edge of the cutting wheel 312 is positioned so as to ride along the inside of the groove 904 in a manner similar to the engagement between wheel 312 and 312 shown in FIG. 4. In this manner, the rail 902 provides a stationary support on both sides of the groove 904 for the package passing there through. This provides cutting wheel 312 with a shearing effect to the packaging that enables easier cutting and the opener 900 is pulled along the edge of the package.

FIG. 10 shows cutter 900 with the handle 400 and trigger 402. The operation of the trigger in this embodiment is identical to that of the embodiment shown and described in FIG. 8. Those of skill in the art will recognize that trigger 402 can be substituted by any known mechanism that will enable a small retraction and extension of the cutting wheel 312 into and out of engagement with a package passing through the slot 341.

While there have been shown, described and pointed out fundamental novel features of the present principles as applied to preferred embodiments thereof, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or embodiment of the present principles may be incorporated in any other disclosed, described or suggested form or embodiment as a general matter of design choice. It is the intention, therefore, to be limited only as indicated by the scope of the claims appended hereto.

What is claimed is:

1. A package opener comprising:
a cutting wheel having a blade;
a friction wheel; and
a package receiving portion for receiving a flange of the package;
wherein when the flange of the package is disposed in said receiving portion, the package opener is moved along the flange to cut open the same.

2. The package opener of claim 1, wherein said cutting wheel and said friction wheel each have gearing meshed together such that said wheels rotate in unison.

3. The package opener of claim 1, wherein said package receiving portion comprises a slot in the opener specifically adapted to receive the flange of a clamshell package, said slot having a predetermined depth corresponding to the flange of the clamshell packaging.

4. The package opener of claim 1, further comprising:
a housing for encasing said cutting wheel and said friction wheel, said receiving portion comprising a slot in said housing; and
a handle connected to said housing for facilitating user movement of the opener along the flange of the package.

5. The package opener of claim 1, wherein said friction wheel comprises a circumferential slot having at lease one edge, said slot configured to receive said blade along said at least one edge.

6. A package opener comprising:
a cutting wheel having a blade;
a friction wheel; and
trigger means attached to one of said two wheels for selectively retracting said wheel from an operable cutting position and extending said wheel into the operable cutting position;
wherein when said trigger is in a retracted position, said wheels are separated to enable the insertion of the package edge into said slot and between said wheels, and wherein when said trigger is activated to the extending position, said wheels engage and the cutting wheel blade engages the surface of the package flange to cut the same.

7. The package opener of claim 6, further comprising:
a housing for encasing said cutting wheel and said friction wheel,
a package receiving portion for receiving a flange of the package; and
a handle connected to said housing for facilitating user movement of the opener along the flange of the package, said trigger means disposed on said handle.

8. The package opener of claim 7, where said receiving portion comprising a slot in said housing, wherein when the flange of the package is disposed in said receiving portion, the package opener is moved along the flange to cut open the same.

8. A package opener comprising:
a cutting wheel having a blade and gearing;
a friction wheel having a slot having at least one edge and gearing meshed with said cutting wheel gearing, said slot adapted to receive said blade along said at least one edge;
a motor connected to at least one of said wheels; and
actuator means for selectively activating said motor thereby causing both of said wheels to rotate via said gearing.

9. The package opener according to claim 8, further comprising:
a housing for encasing said cutting wheel and said friction wheel, said receiving portion comprising a slot in said housing; and
a receiving portion integrated into said housing for receiving a flange of the package to be opened, said receiving portion configured to assist the user in maintaining the flange of the package between said wheels during activation of said motor.

10. The package opener according to claim 9, wherein said housing further comprises:
a handle connected to said housing for facilitating user movement of the opener along the flange of the package, said actuator means being disposed on said handle.

11. The package opener according to claim 9, wherein said receiving portion comprises a longitudinal slot in said housing and positioned so as to enable the flange of the package to pass there through during cutting operation.

12. The package opener of claim 8, wherein said friction wheel comprises a circumferential slot having at lease one edge, said slot configured to receive said blade along said at least one edge.

13. A package opener comprising:
a cutting wheel having a blade;
a rack having a groove for receiving said blade; and
a package receiving portion for receiving a flange of the package;
wherein when the flange of the package is disposed in said receiving portion, the package opener is moved along the edge to cut open the same.

14. The package opener according to claim 13, further comprising:
a housing for encasing said cutting wheel and said rack, said package receiving portion comprising a slot in said housing.

15. The package opener according to claim 14, further comprising a handle connected to said housing for facilitating user movement of the opener along the flange of the package when said flange of the package is disposed in said receiving portion slot.

16. The package opener according to claim 13, wherein said package receiving portion comprises a slot specifically adapted to receive the flange of package, said slot having a predetermined depth corresponding to the flange of the package.

17. A package opener comprising:
a cutting wheel having a blade;
a rack having a groove for receiving said blade;
a package receiving portion for receiving a flange of the package;
trigger means connected to said cutting wheel and adapted to selectively raise and lower said cutting wheel;
wherein said trigger means enables said blade to disengage from said rack and allow insertion of the package flange in between said cutting wheel and said rack.

18. The package opener of claim 17, further comprising a housing for encasing said cutting wheel and said rack, said package receiving portion comprising a slot in said housing.

19. The package opener of claim 17, wherein when the flange of the package is disposed in said receiving portion, the package opener is moved along the edge to cut open the same.
